(19) United States
(12) Patent Application Publication
(10) Pub. No.: US 2022/0301529 A1
(43) Pub. Date: Sep. 22, 2022

(54) SYSTEM AND METHOD FOR DISTRIBUTED MUSICIAN SYNCHRONIZED PERFORMANCES

(71) Applicant: John Nader, Southfield, MI (US)

(72) Inventor: John Nader, Southfield, MI (US)

(21) Appl. No.: 17/636,458

(22) PCT Filed: Sep. 11, 2020
(86) PCT No.: PCT/US2020/050441

§ 371 Date: Feb. 18, 2022

Related U.S. Application Data
(60) Provisional application No. 62/898,799, filed on Sep. 11, 2019.

(51) Int. Cl. G10H 1/00

(52) U.S. Cl. CPC G10H 1/0033; G10H 1/0008; G10H 2240/175; G10H 2210/031; H04N 21/8545

(57) ABSTRACT

A computerized method is provided that enables an interactive multimedia session between a group of geographically distributed musicians. The method includes song arrangements for the interactive multimedia session being specified as a sequence of song parts to be played or sung by each of the participating geographically distributed musicians. Each musician performance is automatically detected on an instrument track along with audio and video for each musician performance on any song part. The timing for each musician performance is automatically captured by the system. The captured performances are transmitted to the musicians participating in a same session of the geographically distributed musicians to produce the effect of playing with other musicians live in the interactive multimedia session. A computer-implemented system and a computer program product stored on a non-transitory computer-readable storage medium for practice of the method are also provided.

### RELATED APPLICATIONS

This application claims priority benefit of U.S. Provisional Application Ser. No. 62/898,799 filed 11 Sep. 2019; the contents of which are hereby incorporated by reference.

### TECHNICAL FIELD

The present invention generally relates to the field of audio production, and in particular, to a system and method enabling musicians to collaborate remotely.

### BACKGROUND

Recording systems have long provided the ability for multiple musicians to record individual performances (performance tracks) and combine them into a single collaborative creative work. Tape-based analog multitrack recorders have evolved into digital computer-based multitrack recorders as a result of personal computers. Advances in Internet connectivity have further evolved multitrack recorders into online services, providing geographically distributed performers with the ability to contribute to a single multitrack recording.

However, despite these advances for music collaboration, the technology is still rooted in the recording of multiple tracks on a linear timeline from start to finish. Collaboration with these technologies is not a live interactive experience. The performances are shared via a cycle of record, upload, download, rewind, and play. Furthermore, these collaborative technologies do not provide a video of the other musicians from which to receive visual cues that naturally enhance the ability to perform an accompaniment. The end result for the performing musician is the effect of interacting with a multitrack recorder, and not with another musician.

Multimedia communication systems have also advanced to provide live audio and video communication between distributed participants. Codec and networking technologies have made high quality audio and video readily available to the average consumer. However, these advances have failed to address the issue of transmission latency. Latency refers to the delay before a transfer of data begins following an instruction for its transfer. To capture, encode, transmit, route, receive, decode, buffer, and play a multimedia stream requires a significant delay. This delay is not perceivable for one-to-many broadcasts, because the receivers only experience a single smooth continuous stream and are unaware of this delay. However, a latency delay can be perceived in person-to-person conversations and conference calls with multiple participants. The delay between one participant speaking, another participant hearing and responding, and then the original participant hearing the response is significant. This delay is very noticeable and can be disruptive to conversations. Participants in these conference calls may adapt to this delay to make it tolerable by simply waiting for a turn to speak. However, collaborating musicians performing together cannot use this technique to adapt to communication latency. Unlike broadcasts and telephone conferences, performing in time and sequence with one another is a fundamental requirement of musicians playing together. As latency increases, it becomes more difficult for each musician to keep in sync (time and sequence) with the group. Worse yet, a pause or gap in the playback has a significant impact on timing and detracts from the overall experience.

For these reasons, neither peer-to-peer live streaming nor online multitrack recorders provide and interactive experience of playing with other musicians. Repetitive user interactions interrupt the creative process. The ability to improvise and dynamically build on ideas is limited.

This limits the effectiveness of online collaboration and diminishes the enjoyment of the experience.

Thus, there exists a need for a computer based system and method to create a live interactive multimedia session between a plurality of geographically distributed musicians without latency between participant contributions.

### SUMMARY OF THE INVENTION

A computerized method is provided that enables an interactive multimedia session between a group of geographically distributed musicians. The method includes song arrangements for the interactive multimedia session being specified as a sequence of song parts to be played or sung by each of the participating geographically distributed musicians. Each musician performance is automatically detected on an instrument track. Musician audio and video are also automatically detected for each musician performance on any song part. The timing for each musician performance is automatically captured by the system with reference to the timing for that part relative to other parts. The captured performances are transmitted to the musicians participating in a same session of the geographically distributed musicians. All received performances from other musicians of the group of geographically distributed musicians are played in accordance with the current specified arrangement of song parts to produce the effect of playing with other musicians live in the interactive multimedia session.

A computer-implemented system for practice of the method includes one or more processors, and one or more non-transitory computer-readable storage mediums containing instructions configured to cause the one or more processors to perform operations that enables an interactive multimedia session between a plurality of geographically distributed musicians.

A computer program product stored on a non-transitory computer-readable storage medium includes computer-executable instructions causing a processor to perform operations that enables an interactive multimedia session between the group of geographically distributed musicians as described above.

### BRIEF DESCRIPTION OF THE DRAWINGS

The present invention is further detailed with respect to the following drawings that are intended to show certain aspects of the invention, but should not be construed as a limit on the practice of the invention, wherein:

FIG. 1 illustrates a simplified network diagram of a setup for two collaborating musicians, each musician utilizing a microphone and camera for performance capture and headphones and video monitor for performance playback in accordance with embodiments of the invention;

FIG. 2 is a diagram showing a music collaboration as a song with multimedia tracks from multiple collaborative participants and how the individual recordings for each track are associated with parts of the song in accordance with embodiments of the invention;

FIG. 3 is a block diagram illustrating performance detection through the use of an adaptive performance detection program with live media input to determine whether the live input represents a musical performance by comparing the live input to statistical analysis of historical performances in accordance with embodiments of the invention;

FIG. 4 is a flow chart of a method of how input performance detection may be utilized to control the capture and transmission of musician performances in accordance with embodiments of the invention;

FIG. 5 illustrates an example of a playback sequence of song parts produced by a song arrangement in accordance with embodiments of the invention;

FIG. 6 depicts an automated looped recording session carried out in accordance with embodiments of the invention;

FIG. 7 shows an example music project data structure for lock-free peer-to-peer data synchronization and persistence in accordance with embodiments of the invention;

FIG. 8 is a flowchart showing an program for identifying the set of currently available media takes to include in an output mix in accordance with embodiments of the invention; and

FIG. 9 is a schematic diagram illustrating an overall view of communication devices, computing devices, and mediums for implementing embodiments of the invention.

### DETAILED DESCRIPTION

The present invention has utility as a system and method that enables an interactive multimedia session between a plurality of geographically distributed musicians. Using embodiments of the invention, song arrangements, synonymously referred to herein as arrangement(s), for an interactive session may be specified as a sequence of song parts to be played by all participating musicians. In embodiments of the invention, musician performances on any instrument track are automatically detected, and the musician audio and video for a detected performance on any song part is automatically captured by the system with reference to the timing for that part. These captured performances are transmitted by the system to musicians participating in the same session. All received performances from other musicians are played in accordance with the current specified arrangement of song parts, which produces the effect of playing with other musicians live. The automated recording and transmission allows continuous participation in a session without requiring interaction from the user to control the system, and these performances are continuously and automatically updated to the latest available recordings for each instrument track and song part.

In embodiments of the invention, user specified song arrangements may run the session for various purposes that may illustratively include, but are not limited to, playing a song from beginning to end, playing a subsection of a song repeatedly, playing a dynamically modified arrangement, and playing along to a system generated arrangement. In specific inventive embodiments, playback of a performance for an instrument track and song part will not begin until the entire recording has been received and the interactive session song arrangement is positioned at that song part. This allows for dynamic improvisation between collaborating musicians, who see and hear one another while playing together, while avoiding the timing lags associated with live streaming technology.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from that embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

All publications, patent applications, patents, and other references mentioned herein are incorporated by reference in their entirety.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also, as used herein, “and/or” refers to and encompasses any and all possible combinations of one or more of the associated listed items, as well as the lack of combinations when interpreted in the alternative (“or”).

As used herein, the term “creative work” refers to a user project contribution including but not limited to instrument tracks, media takes, song parts, and song arrangements. In specific embodiments of the invention, the music project data structure provides a means for a plurality of users to collaborate and share creative work. Modes of collaboration include, but are not limited to, interactive sessions where all user instances of the invention are connected peer-to-peer, upload/download where user instances of the invention individually connect to a central server, and offline where user instances of the invention are not connected to any other instances. The system of the invention must provide access to a shared music project regardless of the mode of usage. All creative work from any other user instance of the invention previously received via project data synchronization must be made available to the user within the user's instance of the invention, regardless of the current connection status to the other user. Furthermore, any creative work captured on the user's instance of the invention while not currently connected must be stored such that it be shared with another user when connected at a later time.

As used herein, the term “song part” means a musical phrase consisting of one or more measures of music which can be a stand-alone musical concept or be combined with other song parts to form a musical composition. In specific embodiments of the invention the user specifies one or more song parts of a musical composition. The specification of a song part may include, but is not limited to, the musical tempo, the beats per measure, and number of measures. The user defines an arrangement by specifying the order in which the song parts are to be played. The specification of the order can include, but is not limited to, a starting point, a linear sequence of steps, the number of times to repeat any given step, and an ending point. Unless specified herein, a song part can include lead-in measures and tail measures.

As used herein, the term “base song part” refers to a song part that is extended by one or more derived song parts.

As used herein, the term “derived song part” refers to a song part which extends another base song part. In certain embodiments of the invention, a derived song part inherits all recordings across all tracks from the base song part. The derived song part can specialize the recordings and configuration of the base song part. Non-limiting examples of specializations include adding recordings, instrument recordings, changing body measure length, changing lead-in measure length, changing tail measure length and changing tempo.

As used herein, the term “song part transformation” refers to modifying the configuration of the song part to automatically transform existing recordings of the song part to match a new configuration. Non-limiting examples of song part transformations are changes to tempo, body measure length, lead-in measure length, and tail measure length.

As used herein, the term “interactive session” means two or more users are simultaneously utilizing instances of invention to connect to each other and synchronize performance recordings for a set of song parts of the same music composition. In specific embodiments of the invention with two or more users are collaborating, the specified arrangement is shared between the users and serves as a framework for an interactive session to coordinate the recording and playback between the users.

As used herein, the term “instrument track” refers to a user selected group of audio and video inputs to be utilized to record a specific musical instrument (e.g., plano, guitar, drums, voice) for one or more song parts within a musical composition. In certain embodiments of the invention the user specifies one or more instrument tracks to contribute to the interactive session.

As used herein, the term “output mix” refers to the combination of media recordings being played back on a set of audio output channels and video displays. This includes, but is not limited to, stereo audio outputs accompanied by a single video display for each performing musician. In a specific embodiment of the invention, while providing an interactive session and playing a song part for this interactive session, the invention utilizes media recording associations across all instrument tracks to the song part to determine which media recordings to include in the output mix.

As used herein, the term “adaptive performance detection” refers to the process of using signal analysis of musical instrument input audio and historical performance data to determine whether or not the input audio contains a user performance. In a specific embodiment of the invention, media recording capture is automated through the use of adaptive performance detection.

As used herein, the term “time window” refers to a short segment of audio samples from which a set of dynamic audio signal features can be extracted for comparison to other time windows. The dynamic audio signal features of each time window, include but are not limited to relative position to musical timing position (e.g., beat and measure) of the time window, and relative position to previous time windows, and the power levels of the audio signal across frequency bands.

As used herein, the term “audio signal features” refers to measurable properties or characteristics on an audio input signal. Non-changing audio signal features are derived from the user configuration of the instrument track and associated audio input. Examples of non-changing audio signal features include but are not limited to input connection type (e.g., ‘SM81 condenser microphone’, ‘Line6 HD500 direct connect’), instrument type (e.g., ‘electric guitar’, ‘vocals’, ‘trumpet’), instrument effect (e.g., ‘clean’, ‘distortion’, ‘compressed’, ‘overdrive’), and performance style (e.g., ‘soft’, ‘lead’, ‘background’). Dynamic audio signal features are continuously derived from the audio input signal of the instrument track. The dynamic changes in these power levels are captured to characterize the input signal by storing timing relative information about the changes within each time window. In a specific embodiment of the invention user performances are detected by capturing signal features and comparing them to a statistical model.

As used herein, the term “auto-muting performance detection” refers to the process of analyzing a brief segment of a recording for an instrument track and song part to determine if that recording contains a performance. Auto-muting performance detection is a non-limiting example of a variant of adaptive performance detection. The goal of this variant is to quickly mute the instrument track when in recording mode and a potential performance is detected. During auto-muting the priority is to ensure that the user stops hearing a previous recording as soon as possible, even at the expense of a false detection result in muting output unnecessarily. These goals may be achieved by providing a shorter duration of audio signal and using a lower score threshold level for transitioning to the detected state.

As used herein, the term “media take performance detection” refers to a process of analyzing a complete recording for an instrument track and song part to determine if that recording contains a performance. Media take performance detection is another non-limiting example of a variant of adaptive performance detection. The goal of this variant is to determine if a completed media take is to be captured for storage and transmitted to other users in an interactive session. During media take performance detection the priority is to prevent the capture of incidental noise on the audio input that would otherwise be stored and shared as if it were a user performance. These goals are achieved by providing the full duration of the captured take as the audio signal, and by providing a moderate score threshold level for detection. It is further noted that another variation of media take performance detection is to introduce a lower score level threshold for storage and a higher score level threshold for transmission. This threshold adjustment produces an intermediate state for a recorded performance when the system is not certain the media take contains a complete performance. In this state the user interface provides a means to classify the media take as a performance. This manual classification of the media take is captured and fed back into the statistical model in addition to controlling the storage and transmission of the media take.

As used herein, the term “automated looped recording” refers to the ability to repeat one or more song parts in a playback loop while automatically capturing any detected performance on an instrument track. Automated looped recording allows a user to record new performances while listening to continuous playback. A specific embodiment of the invention may utilize adaptive performance detection to provide users with automated looped recording functionality.

As used herein, the term “project data replication” refers to a process of copying music project data stored locally on an instance of the invention to another instance of the invention for storage.

As used herein, the term “project data synchronization” refers to a process of comparing the project data storage of an instance of the invention to the data storage of another instance of the invention to determine which project elements require project data replication to bring both projects to the same data version.

As used herein, the term “lock free” refers to allowing multiple music project data elements to make changes to a shared body of work. In some instances, lock free precludes inadvertently overwriting one another's changes.

As used herein, the term “lead-in measures” refers to recorded measures that precede the body of a song part. It is appreciated that in certain embodiments of the invention, lead-in measures are played prior to the body measures of a song part and are mixed with the body of any preceding song part to create a transition between these song parts.

As used herein, the term “tail measures” refers to recorded measures that follow the body of a song part. It is appreciated that in certain embodiments of the invention, tail measures are played after the body measures of a song part and are mixed with the body of any following song part to create a transition between these song parts.

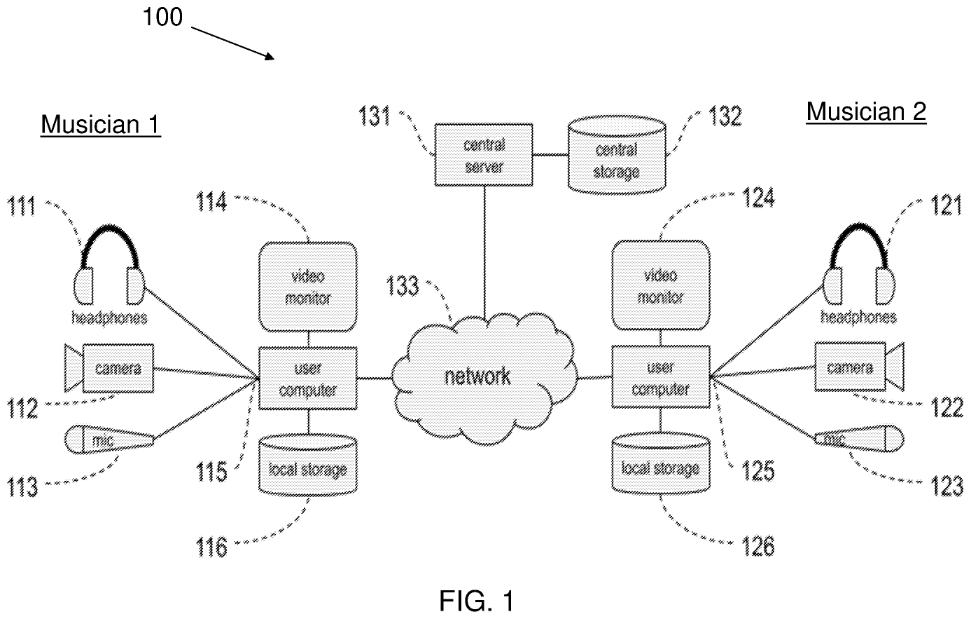

With reference now to the drawings, FIG. 1 illustrates an inventive embodiment of a network diagram of a system 100 of a setup for two collaborating musicians in an interactive session, each musician utilizing a microphone (113, 123) and a camera (112, 122) for performance capture and headphones (111, 121) and video monitor (114, 124) for performance playback.

In the configuration of system 100 for the first user (Musician 1), recorded performances may be played by the computer 115 using the connected headphones 111 for audio and the monitor 114 for video. The first user performances may be captured by computer 115 using the connected video camera 112 and connected audio microphone 113. Similarly, in the configuration for the second user (Musician 2), recorded performances may be played by the computer 125 using the connected headphones 121 for audio and the monitor 124 for video. The second user performances may be captured by computer 125 using the connected video camera 122 and connected audio microphone 123. The first user may utilize local storage 116 for storing the first user performance recordings and any performance recordings received from the second user. The second user may utilize local storage 126 for storing the second user performance recordings and any performance recordings received from the first user. The first user computer 115 and second user computer 125 communicate directly to one another via a network 133. Non-limiting examples of the network 133 may illustratively include any combination of wide area network, local area network, private network, and public Internet. A central server 131 may coordinate establishing secure peer-to-peer communications between the first user computer 115 and second user computer 125. It is appreciated that less than the full complement of musician-users can receive the system performance recordings or compilations thereof and function as conventional contributors. It is further appreciated that for the purposes of the invention, a musician can be a computer generating musical output with the proviso that at least one human musician is participating in the session and generating a performance.

In a specific embodiment of the invention, the first user computer 115 may transfer first user performances from first user local storage 116 to the central server 131 to be stored in central storage 132 in the event that the second user computer 125 is not currently connected to the network 133. The second user computer 125 may retrieve these performances at a later time by connecting to the central server 131 and transferring first user performances from central storage 132 to the second user local storage 126. It is appreciated that FIG. 1 may be extended to additional users by duplicating the equipment setups (i.e., headphones, camera, microphone, video monitor, user computer, local storage) for each additional user. It is appreciated that this system is readily expanded to any number of additional musicians with mere replication of components.

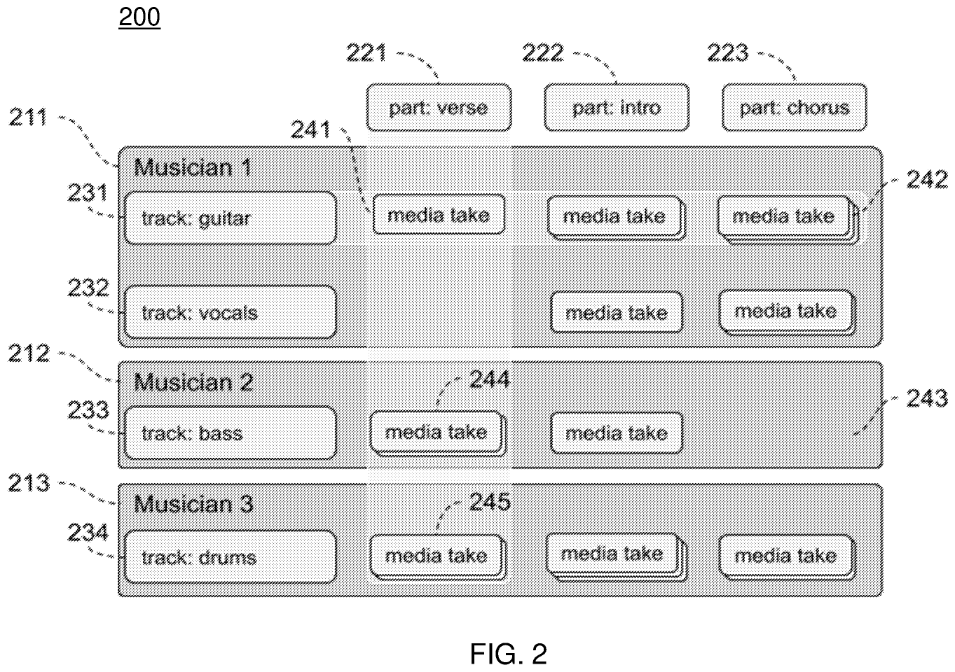

FIG. 2 is an embodiment of an diagram of an inventive method and system showing a music collaboration as a song 200 with multimedia tracks from multiple collaborative participants (Musician 1 (211), Musician 2 (212), Musician 3 (213)) and how the individual recordings for each track (231, 232, 233, 234) are associated with parts of the song 200. FIG. 2 further illustrates the maintained relationships between song parts, instrument tracks, and media takes. Media takes refer to a multimedia recording (e.g., audio, video, music instrument digital interface (MIDI) notes, etc.) of a user performance. In embodiments of the invention, each captured media take may be associated with a specific instrument track and song part. In the illustrated example embodiment shown in FIG. 2, media take 241 is a single recording of the guitar instrument track 231 for the verse song part 221. FIG. 2 also illustrates multiple media takes 242 for a single guitar instrument track 231 and chorus song part 223, and no media takes 243 for a single bass instrument track 233 and chorus song part 223. It is appreciated that this system is readily expanded to any number of additional musicians with mere duplication of components.

Lead-in and tail measures fulfill a specific need by musicians and composers to create natural transitions between other song parts within a song arrangement. Examples include, but are not limited to, pick-up notes at the start of a song part and sustained notes at the end of a song part. The advantage of lead-in and tail measures is that they allow musicians to record continuous and natural sounding transitions that flow in and out of the song part. Additionally, these recordings are associated with a song part and move with that song part when the song arrangement sequence is modified.

Without lead-in and tail support on a song part, the user would be forced to use an alternative, such as recording the lead-in on the previous part or tail on the next part. This would present challenges in recording natural sounding transitions. It would also not ensure transitions are positioned properly when the song arrangement is modified.

It is noted that for an instrument track that has one media recording for the currently playing song part, that media recording is included within the output mix. For an instrument track with multiple media recordings for the currently playing song part, a preferred media recording is selected and included within the output mix. For instrument tracks with no media recordings, nothing is added to the output mix.

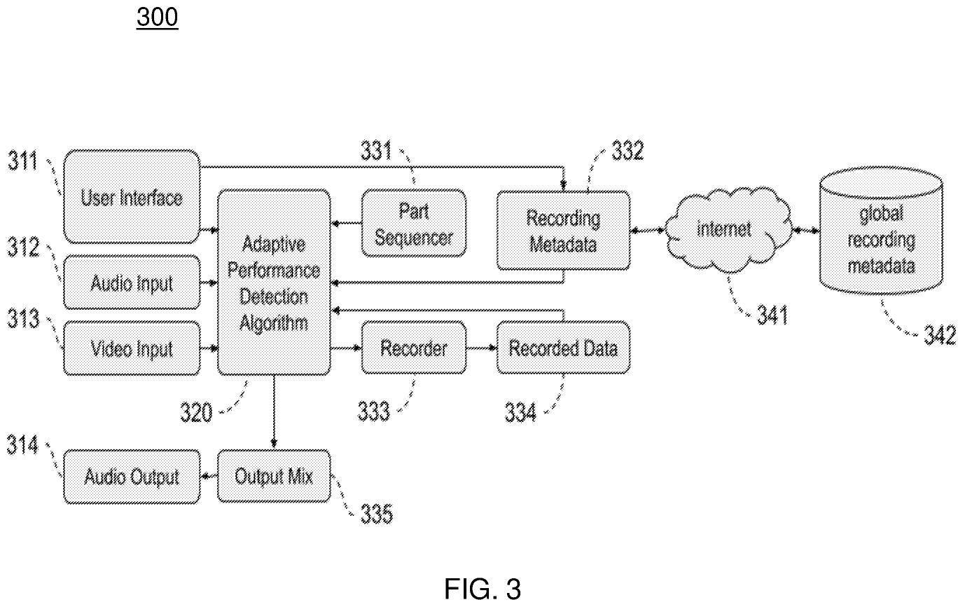

FIG. 3 is a block diagram 300 illustrating performance detection through the use of an adaptive performance detection program 320 with live media input (311, 312, 313) to determine whether the live input represents a musical performance by comparing the live input to statistical analysis of historical performances. The adaptive performance detection program 320 analyzes the instrument track digital audio input signal 312 to determine if the audio input signal 312 contains a user performance. In a specific inventive embodiment, an illustrative non-limiting usage of adaptive performance detection on an instrument track is to control the recorder 333 for media take capture from the instrument track input and to control the output mix 335 for auto-muting previous media takes on the instrument track. In other embodiments of the invention, the control of media take capture provides automated storage of the creative work for playback later and automated share of the creative work with other users participating in an interactive session. Controlling output mix 335 provides automated muting of any previous media takes that would otherwise distract and confuse a user while they attempt to capture a new performance, and automated unmuting to allow the user to see and hear the prior performance for review.

In other embodiments of the invention, user classifications of previous media takes may be incorporated into the statistical database of the performance detection model. Through the user interface 311 the user may categorize previous media takes. These categorizations of media takes may be stored with non-changing and dynamic audio signal features of the media takes in the recording metadata 332. User categories for media take categories include full performance, partial performance, and non-performance. Through usage of the system the user incrementally improves the performance detection model by providing feedback. This feedback process increases performance detection accuracy as new curated entries are added to the statistical dataset.

In specific embodiments of the invention, the user curated dataset of media take recording metadata 332 is transmitted (uploaded) over the internet 341 to a central server global dataset 342, which creates a centralized performance detection model that may be transmitted (downloaded) to other instances of the invention to enhance the performance detection models for other users.

In specific embodiments of the invention, variants of adaptive performance detection are applied to serve different purposes. The adaptive performance detection program analyzes audio input by extracting audio signal features from an audio input signal and then utilizing the performance detection model to calculate a score indicating probability that the audio input signal contains a performance. Variants of the adaptive performance detection may be controlled through changes to the duration of the audio signal provided to the model, the score threshold level for transitioning to a performance detected state, and the score threshold level for transitioning to a performance not detected state.

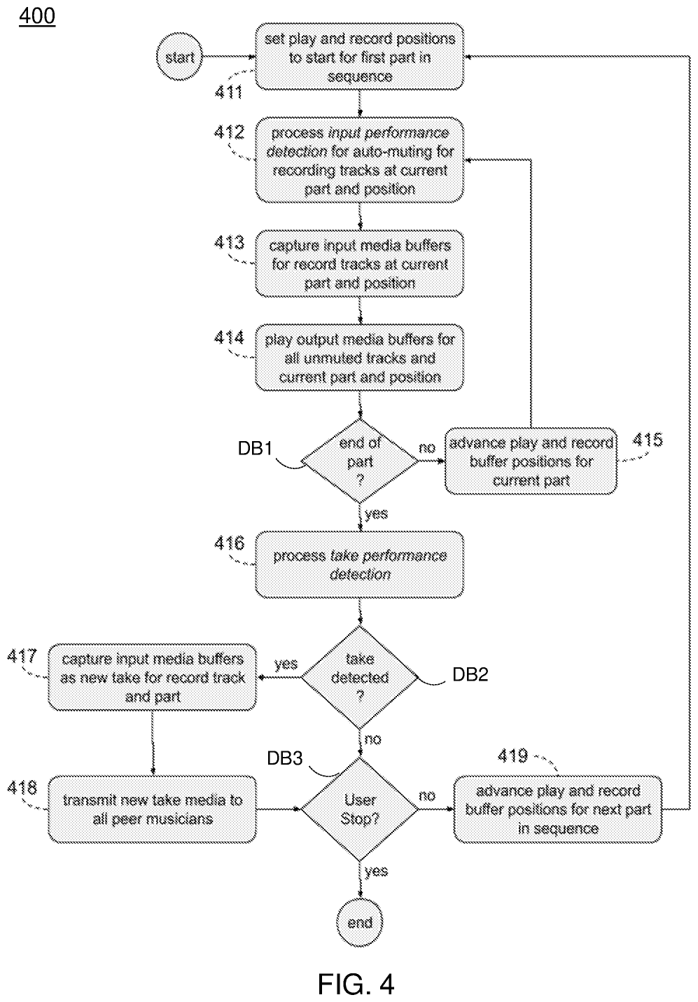

FIG. 4 is a flow chart of an inventive method 400 of how input performance detection may be utilized to control the capture and transmission of musician performances. The process starts by setting play and record positions to start for a first part in a sequence (Block 411). Input performance detection is processed for auto-muting for recording tracks at current part and position (Block 412). Input media buffers are captured for record tracks at current part and position (Block 413). Output media buffers are played for all unmuted tracks and current part and position (Block 414). A determination is then made if the end of the part has been reached (Decision block 1 (DB1)). If the end of the part has not been reached (DB1 is no), the play and record buffers positions are advanced for the current part (Block 415) and the process continues at Block 412. If the end of the part has been reached (DB1 is yes), take performance detection is processed (Block 416). A determination is then made if a take has been detected (Decision block 2 (DB2)). If a take has not been detected (DB2 is no), and the user has not stopped (DB3 is no), the play and record buffers positions are advanced for the next part in the sequence (Block 419) and the play and record positions are set to the next part in the sequence (Block 411) and the process continues as outlined above. If however the user has stopped (DB3 is yes), the process concludes. If a take has been detected (DB2 is yes), the input media buffers captures the detected take for the record track and part (Block 417), and the new take media is transmitted to all peer musicians in the collaboration (Block 418). A determination is then made if the user has stopped (DB3). If the user has not stopped (DB3 is no), the play and record buffers positions are advanced for the next part in the sequence (Block 419) and the play and record positions are set to the next part in the sequence (Block 411) and the process continues as outlined above. If however the user has stopped (DB3 is yes) the process concludes.

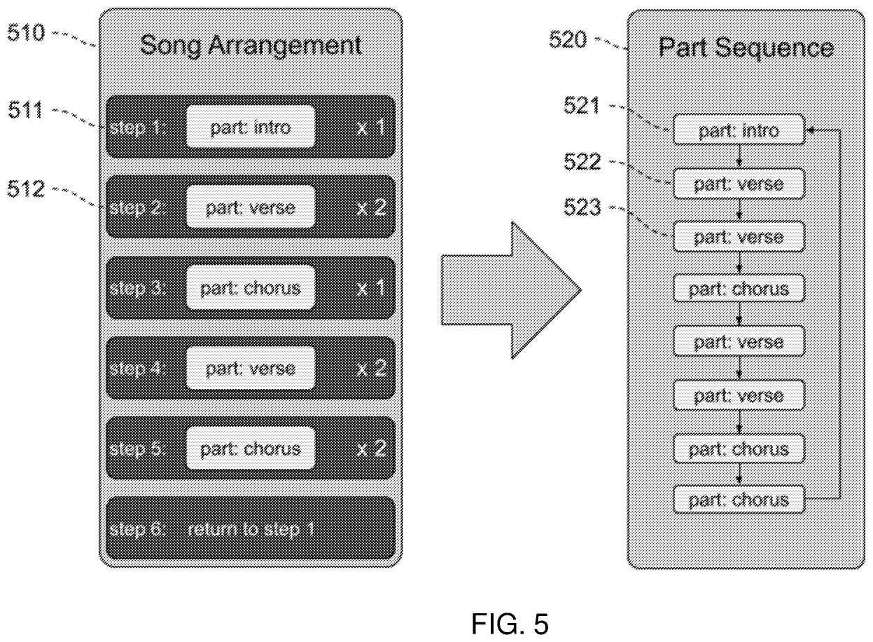

FIG. 5 illustrates an example of an embodiment of a playback sequence 520 of song parts produced from a song arrangement 510. The song arrangement 510 provides a specified sequence of steps, including but not limited to user specified or system order, where each step specifies a song part to play and a number of repetitions to play that part for that step. In the example of FIG. 5, the first step 511 of the song arrangement 510 is the introduction “intro” song part 521 is played once and the second step 512 of the song arrangement 510 results in the verse song part being played once 522 and then played again (repeated) 523.

Continuing with FIG. 5 in conjunction with FIG. 2, a non-limiting example of an inventive embodiment of an interactive session is illustrated. In the illustrative example, three users in an interactive session are online and simultaneously running the same song arrangement 510. In this usage, any performance from any of the three users is captured as a new media take for the user's instrument track and song part currently being played by the interactive session at the time of the performance. While the user musician 1 (211) is performing during the second step 512 of the song arrangement 510, the output mix of the user musician 2 (212)—bass track instrument 233 and media take 244, and the output mix of user musician 3 (213)—drum instrument track 234 and media take 245. The media take 241 is captured for the guitar track 231 and is time adjusted such that the musical timing of all media takes (241, 244, and 245) are aligned. In a specific embodiment of the invention, media recording capture is automated through the use of adaptive performance detection.

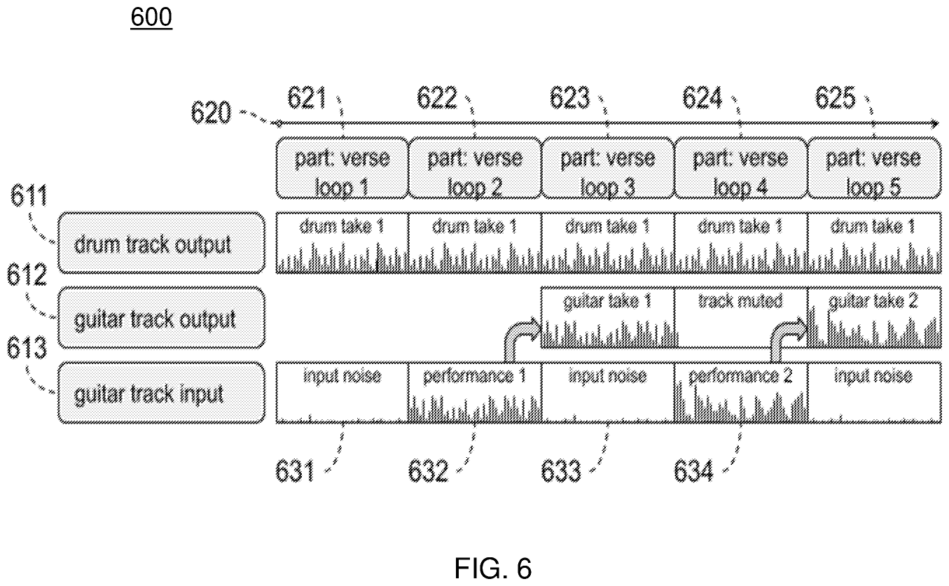

FIG. 6 depicts an inventive embodiment of an automated looped recording session 600 configured with a drum instrument track and guitar instrument track, with a verse song part, and an automated looped recording session for the verse song part and guitar instrument track. In the example shown, the user has also already captured drum take 1 for the verse song part and drum instrument track. The timeline 620 of the recording session illustrates drum track output 611 and the guitar track output 612 contributions to the output mix. During the first loop 621 drum media take 1 is played within the output mix. This allows the user to hear the drum media take 1 playback while considering an appropriate guitar track accompaniment. During the first loop 621 the user may be holding a guitar, but is not yet performing, and this may result in some amount of input noise being recorded. At the end of loop 1 (621) media take performance detection analyzes the audio signal received for the loop (631) and does not detect a performance.

At the start of loop 2 (622), the user begins to perform on the guitar. Drum media take 1 being played so that the user can play along. At the end of loop 2 (622) media take performance detection analyzes the audio signal received for the loop on the guitar instrument track input and detects a performance 632. This results in guitar media take 1 being captured for the guitar instrument track and verse song part.

At the start of loop 3 (623) drum media take 1 and the newly captured guitar media take 1 are both played to the output mix. The user stops performing to listen to how his guitar media take 1 and drum media take 1 sound together. During the loop 3 (623) the user is holding a guitar while listening to the output mix. This produces some amount of input noise 633 during loop 3 (623). Auto-muting performance detection analyzes this noise, but does not detect a performance, so no automatic muting of the guitar instrument track output 612 occurs. At the end of loop 3 (623) media take performance detection analyzes the audio signal received for the loop and does not detect a performance, so no new media take is captured.

At the start of loop 4 (624) the user begins to perform on the guitar. Auto-muting performance detection analyzes the input signal and detects a performance. This results in guitar take 1 being automatically muted in the output mix to allow the user to perform without distraction. At the end of loop 4 (624) media take performance detection analyzes the audio signal received for the loop on the guitar instrument track input and detects a performance (634). This results in guitar media take 2 being captured for the guitar instrument track and verse song part. At the start of loop 5 (625) media take 2 replaces media take 1 as the preferred take for the guitar instrument track in the output mix.

In a specific embodiment of the invention, the media take performance detection performs analysis just prior to the end of the loop, giving enough time to detect a performance and capturing prior to the loop end. This accommodates the lag between audio input and output on personal computing systems and allows the new media take to begin playback immediately in the following loop, instead of waiting for the final remaining audio to arrive. All but the last few milliseconds of a recording will be sufficient to make an accurate performance detection. The remainder of the recording is added to the media take as it arrives from the media inputs.

In certain embodiments of the invention, the music project data structure is specifically designed to support project data replication and project data synchronization. The project data replication refers to the process of copying music project data stored locally in local storage 116 in an instance of the invention 115 for musician 1 to another instance of the invention 125 for musician 2 for storage in local storage 126. Project data synchronization refers to the process of comparing the project data storage 116 of an instance of the invention to the data storage 126 of another instance of the invention to determine which project elements require project data replication to bring both projects to the same data version.

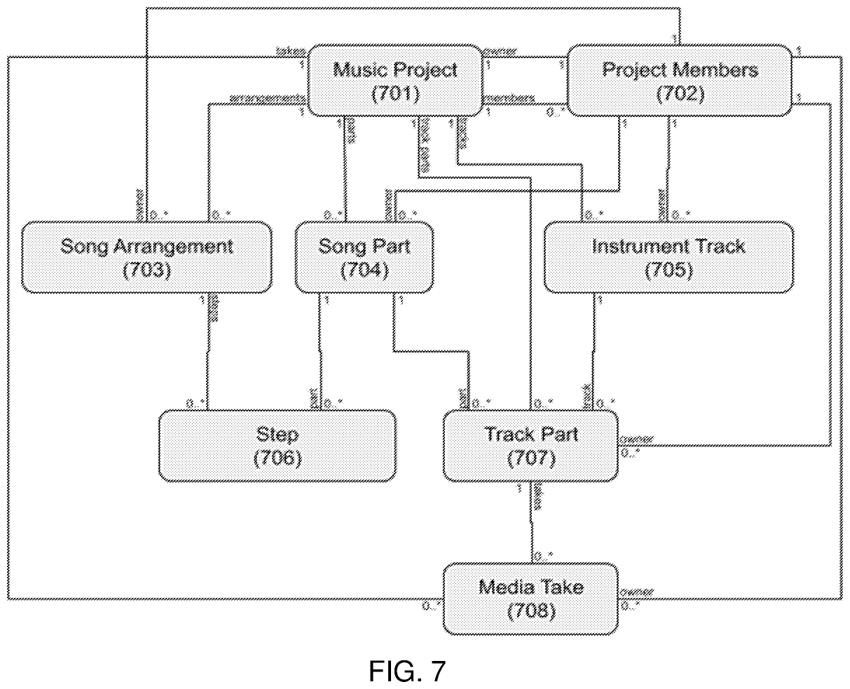

FIG. 7 shows an exemplary inventive embodiment of a music project data structure 700 for lock-free peer-to-peer data synchronization and persistence, and illustrates the project elements of the music project data structure 700 and the interrelationships between these project elements. The music project data structure 700 provides a structure for a plurality of users to collaborate and share creative work. A music project 701 represents an instance of a body of creative work with a list of one or more contributing project members 702. One project member 702 is designated as the owner of the music project 701. A music project 701 has zero or more instrument tracks 705. Each instrument track 705 has an owner project member 702. A music project 701 has zero or more song parts 704. Each song part has an owner project member 702. A music project 701 has zero or more track parts 707. Each track part 707 has an associated instrument track 705 and song part 704. Each track part 707 has an associated owner project member 702 that must be the same as the track part instrument track owner. A music project has zero or more media takes 708 that belongs to a list of media takes for an associated track part 707. Each media take 708 has an associated owner project member 702 that must be the same as the media take track part owner. A music project 701 has zero or more song arrangements 703. Each song arrangement 703 has an owner 702. A song arrangement 703 contains zero or more steps 706, where each step 706 has an associated song part 704.

When a project data structure entity such as structure 700 as shown in FIG. 7 is created through usage of embodiments of the invention, the entity is assigned an owner identifier, a project identifier, and a generated 128-bit standard universally unique identifier (UUID) as the entity identifier. This usage of UUIDs makes it statistically impossible for two or more users working on the same music project to generate that same identifier for different elements. The project identifier is used to determine the scope during data replication and synchronization between different instances of the invention. The owner identifier is used to identify the data master for the entity, to control modifications to the entity, and to validate the origin of the entity.

Each track part 707 of the music project data structure 700 holds a list of media takes 708 and associates them to exactly one instrument track 705 and song part 704. This allows multiple performance recordings for a specific instrument to be associated to a specific section of a song while keeping them decoupled from the overall structure of the song. This decoupling provides users with the ability to create and modify song arrangements 703 and steps 706 without conflicting with recordings from other users. This is essential to enabling interactive session as well as providing off-line collaboration.

The direct relationship between the music project and project elements provides for project data synchronization to scan and detect entity version changes despite the absence of intermediate relationships with the music project. A non-limiting example of the invention utilizing this capability is the invention receiving data for an instance of a media take 708 prior to receiving the track part 707, song part 704, or instrument track 705 associated with the media take. The media take data 708 may be persisted as a member of the music project 701 collection of media takes with local storage 116. At this point in the process the media take cannot be played because the required song part, instrument track, and track part data have not yet been received. Subsequent project data synchronization completes the project entity structure required for playing the media take incrementally. Project entity data for song part, instrument track, and track part data may be added to local storage in any order. It is appreciated that in this context, song part includes lead-in or tail measures, if present.

As part of the post-performance production process, an inventive system in some embodiments transforms each recording to match a modified song part configuration based on the tracks created.

Within the creative process of musical composition, it is typical to make changes that impact fundamental aspects of the song structure. This can be disruptive when collaborating with distributed recording software, because a fundamental change can require coordinated changes across recordings from all or a portion of project contributors.

In certain embodiments of the invention, song part transformations are utilized to allow one musician to affect fundamental changes to song part configuration without modifying the recordings of other musicians. This is achieved by the present invention through capturing and storing the current song part configuration with each captured recording. When a song part configuration change is made, each recording is transformed to meet the new configuration while still maintaining a copy of the original unmodified recording. This enables a lock free distributed system wherein a musician can make a configuration change while another musician captures new recordings.

A non-limiting example within a certain embodiment of the invention is a collaboration on a music project song part with a drummer and a bass player. The drummer creates a song part that is two measures long. The drummer records a drum beat. After synchronizing, the bass player reconfigures the song part for four measures. The system transforms the original drum recording by repeating it once to increase the length from two to four measures. The bass player records a four measure bass line. After synchronizing, the drummer can hear the four measure version of his drum part accompanied by the four measure base line.

A common practice in music production is to reuse musical recording tracks for some instruments or vocals while creating new recordings for other instrumental or vocal performances. By way of a non-limiting example, a song with three verses illustratively has a rhythm section that includes guitar, bass, and drums, which repeat the same music for each of the three verses. The vocals section requires different lyrics for each of the three verses. In certain embodiments of this invention, the rhythm section can be recorded on a single song part, called Verse, with recordings for guitar, drums, and bass. The unique vocals can be captured on three derived song parts, called Verse 1, Verse 2, and Verse 3, each of which are derived from the Verse song part.

One benefit of this inventive approach is that each verse can contain unique vocals, while only recording the rhythm section once. Another benefit is that any rhythm section musician can change the recordings for the Verse base song part, and those changes are automatically propagated to the derived song parts Verse 1, Verse 2, and Verse 3.

An additional benefit of this inventive approach is that modifications can be synchronized between musicians in a lock free manner. In certain embodiments of the invention, a vocalist can create a Verse 4 with new vocals, while concurrently a guitarguitarist records a version for the Verse base song part. In this non-limiting example, both the new guitar part and new vocal part will be cleanly merged into Verse 4 with no need to lock the project or manually resolve any merge conflicts.

In contrast, conventional recording software would accomplish this task by copying rhythm section recordings from Verse 1 to Verse 2, Verse 3 and Verse 4. This conventional approach is much more manually intensive and error prone. Traditional recording software also precludes a lock free distributed music project, because it requires one musician to copy and paste recordings owned by another musician. As a result, the present invention represents an advance in computer-based music production.

Embodiments of the invention provide the ability to maintain a stable representation of the music project while the music project is being concurrently modified by multiple sources, including but not limited to music project changes being made by the local user, music project changes being received from one more other users, and music project changes received from the central server. A media take selection program identifies the correct set of media takes to add to the output mix for the currently playing step in a song arrangement.

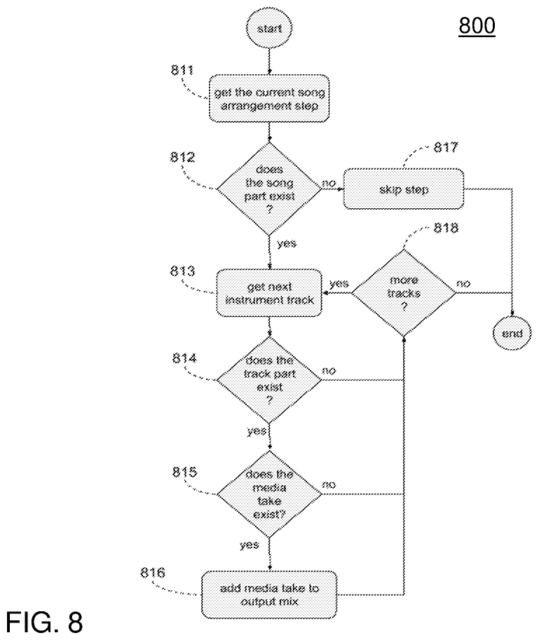

FIG. 8 is a flowchart showing an embodiment of an inventive computer program 800 for identifying the set of currently available media takes and for selecting which media takes to include in an output mix, while also handling any partially synchronized data that results in references to missing project elements. The program is typically stored on a non-transitory computer-readable storage medium.

At the start of this program, the current step of the current song arrangement is retrieved (Block 811). If the song part referenced by the step is missing (Decision block 812 is no), the step is skipped by advancing to the next step in the song arrangement (Block 817). If the song part is present (Decision block 812 is yes), the program begins looping through each instrument track (813). For each instrument track, the program determines if a track part associated with the instrument track and song part is present (Decision block 814). If the track part is missing (Decision block 814 is no), the program advances to the next instrument track (818). If the track part is present (Decision block 814 is yes) the program determines if the track part has an available media take (Decision block 815). If the track part does not have a media take to play (Decision block 815 is no), the program advances to the next instrument track (818). If the track part does have a media take (Decision block 815 is yes), the media take is added to the set of media takes to be added to the output mix (Block 816), and then the program advances to the next instrument track (Decision block 818 is yes). If there are no more tracks (Decision block 815 is no) the program concludes. Once all instrument tracks have been processed, the complete set of media takes to add to the output mix is returned from the program.

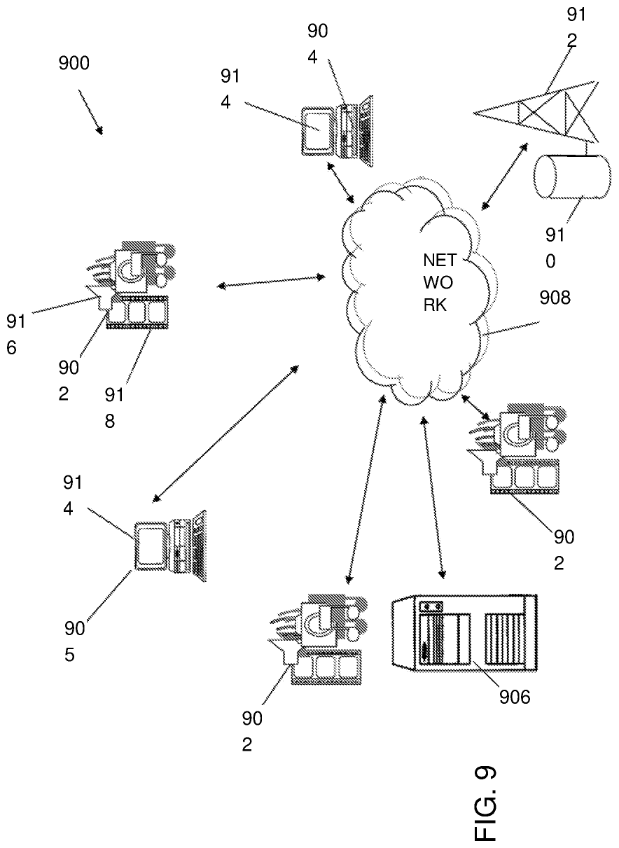

FIG. 9 is a schematic diagram illustrating an overall view of communication devices, computing devices, and mediums for implementing a system and method for providing an interactive multimedia session between a plurality of geographically distributed musicians

The system 900 includes multimedia devices 902 and desktop computer devices 904 configured with display capabilities 914 and processors for executing instructions and commands, as well as running software and apps. The multimedia devices 902 are optionally mobile communication and entertainment devices, such as cellular phones, tablets, laptops, and mobile computing devices that in certain embodiments are wirelessly connected to a network 908. The multimedia devices 902 typically have video displays 918 and audio outputs 916. The multimedia devices 902 and desktop computer devices 904 are optionally configured with internal storage, software, and a graphical user interface (GUI) for carrying out elements of the system and method for providing an interactive multimedia session between a plurality of geographically distributed musicians in accordance with embodiments of the invention. The network 908 is optionally any type of known network including a fixed wire line network, cable and fiber optics, over the air broadcasts, local area network (LAN), wide area network (WAN), global network (e.g., Internet), intranet, etc. with data/Internet capabilities as represented by server 906. Communication aspects of the network are represented by cellular base station 910 and antenna 912. In a preferred embodiment, the network 908 is a LAN and each remote device 902 and desktop device 904 executes a user interface application (e.g., Web browser) to contact the server system 906 through the network 908. Alternatively, the remote devices 902 and 904 may be implemented using a device programmed primarily for accessing network 908 such as a remote client.

The software for the system and method for an interactive multimedia session between a plurality of geographically distributed musicians may be resident on tablets 902, desktop or laptop computers 904, or stored within the server 906 or cellular base station 910 for download to an end user and typically includes computer program stored on a non-transitory computer-readable storage medium. Server 906 may be implemented as a cloud-based service for implementing embodiments of the platform with a multi-tenant database for storage of separate client data for each independent musician, group, or organization.

### Other Inventive Embodiments

In a specific inventive embodiment, performance detection may also include video of the user. In a system with video, a system may learn to recognize the moments before a musician is about to perform through a processed image stream. Examples illustratively include observing the user mouth approaching a microphone, hand placement on piano keys or guitar fretboard, or lifting a trumpet or violin. This could significantly improve performance detection timing to mute any previous recording even prior to the user producing an audio signal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A computerized method that enables an interactive multimedia session between a plurality of geographically distributed musicians, comprising:
specifying song arrangements for the interactive multimedia session as a sequence of song parts to be played or sung by each of the participating plurality of geographically distributed musicians;
automatically detecting each musician performance of each of the participating plurality of geographically distributed musicians on at least one instrument track to define a detected musician performance;
automatically detecting musician audio and video for the detected musician performance on any song part that is automatically captured with reference to the timing for that part to define a captured musician performance;
transmitting the captured musician performances to at least one of the plurality of geographically distributed musicians participating in a same session; and
wherein all received performances from other musicians of the plurality of geographically distributed musicians are played in accordance with the current specified arrangement of song parts to produce the effect of playing with other musicians live in the interactive multimedia session.

2. The method of claim 1 wherein the musician performances are continuously updated to the latest available recordings for each instrument track and song part.

3. The method of claim 1 wherein the musician performances are automatically updated to the latest available recordings for each instrument track and song part.

4. The method of claim 1 wherein the specified arrangement of the song includes at least one of: playing a song from beginning to end, playing a subsection of a song repeatedly, playing a dynamically modified arrangement, and playing along to a system generated arrangement.

5. The method of claim 1 further comprising playback of a performance for the instrument track and the song part will not begin until the entire recording has been received as received performances and the interactive session song arrangement is positioned at that song part.

6. The method of claim 1 wherein the interactive multimedia session includes at least one instances where the plurality of geographically isolated musicians are: connected peer-to-peer, upload/download where the musicians are individually connected to a central server, and offline where the musicians are not connected.

7. The method of claim 1 wherein the song part comprises musical tempo, beats per measure, and number of measures.

8. The method of claim 1 wherein the song part further comprises at least one lead-in measure or at least one tail measure.

9. The method of claim 1 wherein transitions between song parts within the current specified arrangement are played by mixing song part lead-in measures with preceding song part body measures, and mixing song part tail measures with following song part body measures.

10. The method of claim 1 wherein the instrument track is a user selected group of audio and video inputs used to record a specific musical instrument for one or more song parts within a musical composition.

11. The method of claim 1 further comprising an adaptive performance detection program that analyzes the instrument track to determine if the instrument track contains a user performance.

12. The method of claim 11 wherein the adaptive performance detection program analyzes audio input by extracting audio signal features from an audio input signal and then calculates a score indicating probability that the audio input signal contains a performance.

13. The method of claim 1 wherein each of a plurality of music project data elements contributing to the interactive multimedia session is assigned an owner identifier, a project identifier, and a generated standard universally unique identifier (UUID) as an entity identifier.

14. (canceled)

15. The method of claim 13 wherein the interrelationships between the music project data elements provide lock-free peer-to-peer data synchronization.

16. The method of claim 13 wherein the interrelationships between the music project data elements provide lock-free data synchronization is between one of a client and a central server.

17. The method of claim 1 further comprising providing an automated looped recording session after the same session.

18. (canceled)

19. The method of claim 1 further comprising automatically transforming a song part recording to a new configuration while maintaining with the new configuration aligning with any other song part configuration in a lock free manner.

20. The method of claim 1 wherein the song parts comprises at least one base song part and at least one derived song part.

21. A computer-implemented system, comprising:
one or more processors; and
one or more non-transitory computer-readable storage mediums containing instructions configured to cause the one or more processors to perform operations that enables an interactive multimedia session between a plurality of geographically distributed musicians as described in claim 1.

22. A computer program product stored on a non-transitory computer-readable storage medium comprising:
computer-executable instructions causing a processor to perform operations that enables an interactive multimedia session between a plurality of geographically distributed musicians as described in claim 1.
